(19) United States
(12) Patent Application Publication
(10) Pub. No.: US 2026/0217011 A1
(43) Pub. Date: Jul. 30, 2026

(54) APPLICATION SYSTEM HAVING A TRANSFER BELT

(71) Applicant: tesa SE, Norderstedt (DE)

(72) Inventors: Deniz Nick AKIN, Hamburg (DE); Lukas HERBST, Ellerau (DE); Joachim MARTEL, Goettingen (DE)

(73) Assignee: tesa SE, Norderstedt (DE)

(21) Appl. No.: 19/141,861

(22) PCT Filed: Dec. 13, 2023
(86) PCT No.: PCT/EP2023/085546

§ 371 Date: Jun. 20, 2025

(30) Foreign Application Priority Data
Dec. 22, 2022 (DE) 10 2022 134 629.3

(51) Int. Cl. B32B 37/00; C09J 5/00

(52) U.S. Cl. CPC B32B 37/025; C09J 5/00

(57) ABSTRACT

Systems and methods having a transfer belt are provided and comprise a) a dispenser device having dispenser units, an adhesive-element guide system, and a transfer unit, and b) an application device arranged on an automated moving unit and a conveying element and an application element. The systems are designed such that (i) the application device is moved into a transfer position relative to the dispenser device by means of the automated moving unit, and (ii) the systems may pick up adhesive elements and apply the adhesive elements to a substrate to be bonded to.

The invention relates to an application system for applying adhesive elements to substrates to be bonded, to an application device and to a dispenser device for use in a corresponding application system, and to a method for applying adhesive elements to substrates to be bonded by a corresponding application system.

The use of adhesive elements is nowadays an important constituent part of many modern manufacturing methods. In the process, corresponding adhesive elements are not only used for fastening components to a substrate, but serve in particular also for closing openings in a substrate. In most instances, such openings are present for manufacturing-related reasons and represent potential weak points in the later product, through which moisture or contaminants may ingress, for example. The use of suitable adhesive elements, which are in most instances tacky on one side, for closing corresponding openings in substrates represents a simple and time-efficient and cost-efficient solution for closing corresponding openings and for precluding unwanted ingress of contaminants, wherein such adhesive elements which due to their production method are also referred to as die-cut blanks are already regularly used nowadays for this purpose in the prior art.

In principle, it would be conceivable to place the corresponding adhesive elements manually on a substrate. In the course of progressing automation and in view of a continued interest in providing efficient method management, which is prone to as few errors as possible, automation-capable application devices which serve to apply adhesive elements to a substrate to be bonded have however been developed. A wide range of requirements are set for corresponding application devices. Thus, corresponding application devices must enable in particular a reliable and reproducible application of adhesive elements to the substrates, wherein it is desirable that a high throughput rate is to be achieved.

The comparatively simple solutions in the prior art are in most instances based on so-called “pick & place”, wherein the end effector of a robotic arm picks up each adhesive element individually from a spaced-apart dispenser device and subsequently places said adhesive element on the substrate. This method management is however considered in most cases to be disadvantageous in terms of time-efficiency and cost-efficiency.

In order to optimize the handling efficiency and to avoid complex feeding systems, in which the required adhesive elements must usually be guided as a tape from a separate dispenser device to the application device, application devices have been designed with an integrated dispenser arrangement for adhesive elements, in which the provision of the adhesive element and the application device can be embodied conjointly, for example as part of an end effector of a robotic head. Corresponding application devices with an integrated dispenser device often rely on a refill system for an efficient supply of adhesive elements, in which adhesive rolls populated with adhesive elements are inserted into the dispenser arrangement, which adhesive rolls can be removed and replaced again after application of the adhesive elements contained on the adhesive roll. Many modern application devices rely on concepts with so-called refill cartridges, in which the adhesive rolls populated with adhesive elements are usually disposed in a housing. The use of corresponding refill cartridges regularly permits a supply, which is particularly fast, reliable and insusceptible to error, of the application device with the adhesive elements required for the application, wherein the refill cartridges are advantageous particularly even during storage and in transport.

Despite the advantages associated with the use of removable adhesive rolls populated with adhesive elements and in particular the use of refill cartridges, their use is sometimes also considered disadvantageous from other points of view. In particular, the adhesive rolls freed from adhesive elements, i.e. mostly the emptied carrier roll and the remaining unwound liner, often cause waste after use, which can only be recycled very laboriously, especially in older systems. In addition, the time-efficient and cost-efficient production of fresh adhesive rolls which are populated with adhesive elements and can be used, for example, directly in application devices or in a refill cartridge is also considered challenging in many cases. The application devices, which are in most instances used as end effectors of an industrial robot, are regularly limited in terms of maximum weight, so that the adhesive rolls used and populated with adhesive elements can in most instances only have a limited width and length, which also limits the maximum size of the adhesive elements.

A particular set of issues of the solutions known from the prior art, which is derived both for external tape feeds of adhesive elements and for embodiments with integrated dispenser arrangements, is that different types of adhesive elements are regularly required for the complete bonding of substrates, said types differing, for example, in terms of the dimensions or the chemical nature of the adhesive compounds used. This set of issues is reinforced by the fact that the sequence in which the different types of adhesive elements are required is predefined by the working path of the end effector, which should ideally actuate the regions to be bonded in a sequence that is determined by the shortest distances and does not have to take into account any different requirements of the adhesive positions for minimizing the routes and optimizing the working efficiency. Accordingly, the need for different adhesive elements represents an impediment to efficiency in many methods of the prior art.

According to the opinion of the inventors, a satisfactory solution to this problem has not yet been found in the prior art. Providing two or more tape-shaped feeds with different adhesive elements to the movable end effector is regularly not possible in an efficient manner, in particular in the case of collaborative robots, because the weight of these applicators often amounts to 20 kg or more. Equipping the end effector with a plurality of integrated dispenser arrangements for different adhesive elements is in most instances not a viable way, especially from the points of view of weight engineering. The theoretical idea of preparing individual integrated or external adhesive element rolls of the dispenser device with complex adhesive element arrangements of different adhesive elements on the respective liner, the sequence of which corresponds to the requirements of the subsequently sequentially actuated adhesive positions of the substrate, would be associated with considerable production complexity so that this would hardly be practically implementable according to the opinion of the inventors. In particular, any complication, e.g. a faulty or missing adhesive element, would jeopardize the entire workflow, in particular also for substrates to be bonded subsequently.

In practice, in volume production, against this background, the person skilled in the art to date has in most instances only the option of bonding different adhesive positions with different requirements for the adhesive elements successively at different workstations and/or using different application devices, which significantly increases the space requirement and the equipment expenditure.

The primary object of the present invention was to eliminate or at least minimize the disadvantages of the prior art.

In particular, it was the object of the present invention to specify a powerful application system for applying adhesive elements to substrates to be bonded as well as corresponding dispenser devices and application devices to be used in this application system.

It was an object of the present invention here that the application system should be able to be operated with a high degree of operational safety and process reliability, wherein in particular a tape-like connection between the dispenser device and the application device, which could hinder or endanger workers employed in the process, is to be avoided.

Moreover, the application system to be specified should be ideally low-maintenance and in particular dispense with the need for refilling steps for adhesive tape rolls and the replacement of refill cartridges in order in this respect to also reduce the resultant amount of waste that is difficult to recycle.

In particular, however, it was an object of the present invention that with the application system to be specified, different adhesive positions on a substrate, which set different requirements for the adhesive elements, can be efficiently bonded using the optimal adhesive elements without the route traveled for this purpose by the application device and/or the weight of the application device having to be increased in an adverse manner.

It was an object of the present invention here that with the application system to be specified, a plurality of substrates with adhesive position-optimized adhesive elements can be bonded successively without significant changes, even if the substrates differ considerably in terms of the type, number or position of the adhesive positions.

It was a desirable target that the application system to be specified can also be embodied with a collaborative robot, i.e. a working robot whose use is possible in a workstation in which also workers work on the substrate without endangering their safety, which in particular places strict specifications on the maximum weight of the application device.

Moreover, it was an object of the present invention to provide a corresponding method for applying adhesive elements to substrates to be bonded using the application system to be specified.

The inventors of the present invention have now found that the above-described objects can be achieved when a specific dispenser device and a particular application device are used, which each rely on the use of a revolving conveyor belt having a reduced-adhesion surface, also referred to as a transfer belt, and which can interact in the application system in a specific manner as defined in the claims, in an application system.

This concept is based on the fact that a substrate-specific, predetermined arrangement of adhesive elements, which comprises a multiplicity of different adhesive elements, which are disposed in a sequence corresponding to the actuation of the corresponding adhesive positions on the substrate to be bonded by the application device, is generated in the dispenser device. This composition of different adhesive elements optimized for the need of subsequent adhesive element dispensing, which adhesive elements differ, for example, in terms of their size and/or the chemical nature of the adhesive compound used, is transferred to the application device. For this purpose, the application device disposed on an automated motion unit is moved toward the dispenser device, so that a transfer of the previously assembled adhesive element arrangement from the transfer belt of the dispenser device to the transfer belt of the application device can be performed. The transfer belt of the application device herein is sized in such a way that it can accommodate the entire adhesive element arrangement. After the corresponding populating of the application device with adhesive elements optimized for the substrate, the application device can be reset to the application mode in which the application device actuates the adhesive positions to be bonded of the substrate by the motion unit. At the first adhesive position, the application device picks up a first adhesive element of the adhesive element arrangement and applies it to the substrate. Subsequently, the next adhesive element of the adhesive element arrangement from the reservoir of adhesive elements is displaced to the application region on the revolving conveyor belt of the application device, in which application region it can in turn be received and applied by the application element at the next adhesive position of the substrate. Thus, the adhesive elements of the adhesive element arrangement, which are temporarily stored on the transfer belt of the application device so to speak, can be applied piece by piece to the substrate, wherein the application device can advantageously perform a path-optimized actuation of the adhesive positions, because the availability of the adhesive elements in the application region is adapted to the individual requirements of the adhesive position.

Advantageously, the use of tape-shaped feed connections between the dispenser device and the application device, which span the gap between these devices, as well as the use of integrated dispenser device in the end effector, can be dispensed with in a corresponding application system. This makes it advantageously possible to embody the application device to be particularly light and to minimize the amount of waste generated, particularly when recyclable refill cartridges are used in the dispenser device. Moreover, the corresponding application system is very robust and insusceptible to errors, wherein it is possible in an efficient way to optimally bond even completely different substrates, which differ in terms of number and/or type and/or position of the adhesive position, because a modified and substrate-optimized sequence of adhesive elements can be readily provided by the dispenser device and transferred to the application device. Since the dispenser device can be advantageously embodied to be stationary and thus is subject to comparatively minor requirements with regard to the weight and dimensions, dispenser units for a large number of different adhesive elements can be provided in the dispenser device without this leading to efficiency losses, so that, for example, adhesive elements which are only rarely needed and which would usually require manual application in conventional production lines, if a separate automated dispenser device for these adhesive elements is not justified by the low demand, can be provided “on demand”. In summary, an improved adhesive element variance in association with a simultaneously high application rate of the individual adhesive elements and consequently an advantageous time efficiency and cost efficiency, is thus in particular achieved by a corresponding application system.

The objects stated above are thus achieved by the subject matter of the invention as defined in the claims. Preferred design embodiments according to the invention are derived from the dependent claims and the explanations hereunder.

Embodiments which are hereinafter designated as preferred are combined in particularly preferred embodiments with features of other embodiments designated as preferred. Very particularly preferred, therefore, are combinations of two or more of the embodiments designated below as particularly preferred. Also preferred are embodiments in which a feature of one embodiment that is designated in any degree as preferred is combined with one or more further features of other embodiments that are designated in any degree as preferred. Features of preferred application devices, dispenser devices and methods are derived from the features of preferred application systems.

The invention relates to an application system for applying a multiplicity of adhesive elements to substrates to be bonded, comprising:
a) a dispenser device comprising:
a1) two or more dispenser units comprising in each case a multiplicity of adhesive elements or at least an adhesive element precursor from which the dispenser device can produce a multiplicity of adhesive elements, wherein the dispenser units are configured to deliver adhesive elements,
a2) an adhesive element guiding system, and
a3) a transfer unit comprising a revolving conveyor belt having a reduced-adhesion surface and a dispensing edge,
wherein the dispenser device is configured to transfer adhesive elements delivered from the dispenser units to the conveyor belt of the transfer unit by way of the adhesive element guiding system, and to hereby generate on the reduced-adhesion surface an adhesive element arrangement from a multiplicity of adhesive elements, wherein the adhesive element arrangement comprises adhesive elements from different dispenser units,
and
b) an application device which is spaced apart from the dispenser device and is disposed on an automated motion unit, comprising:
b1) a conveyor element comprising a revolving conveyor belt having a reduced-adhesion surface, which extends through a receiving region, a retrieving region and a reservoir region, and
b2) an application element,
wherein the application device is configured in such a way that a multiplicity of adhesive elements, which have been applied to the reduced-adhesion surface in the receiving region, can be conveyed into the reservoir region by way of the conveyor element and that an adhesive element located in the reservoir region can be conveyed into the retrieving region by way of the conveyor element,
wherein the application device is configured to receive an adhesive element disposed on the conveyor belt of the conveyor element in the retrieving region by way of the application element and to apply said adhesive element to a substrate to be bonded,
wherein the application system is configured in such a way that the application device can be moved relative to the dispenser device to a transfer position by way of the automated motion unit, in which transfer position the application system is configured in such a way that the adhesive elements of the adhesive element arrangement can be transferred over the dispensing edge onto the conveyor belt by the transfer unit and in the receiving region be applied to the reduced-adhesion surface of the conveyor element in such a way that at least part of the transferred adhesive elements is conveyed into the reservoir region by way of the conveyor element, and
wherein the application system is configured to, after transferring the adhesive elements of the adhesive element arrangement onto the conveyor element, in an application mode, convey adhesive elements from the reservoir region into the retrieving region, to receive the adhesive elements by way of the application element and to apply said adhesive elements to a substrate to be bonded.

The application system according to the invention serves to apply adhesive elements to substrates to be bonded, for example vehicle components, such as headliners. The application system herein comprises a dispenser device and an application device which is spaced apart from the dispenser device and is disposed on an automated motion unit, wherein these two devices interact with one another to enable the advantageous functionality of the application system according to the invention.

It can be seen as an advantage of the application system according to the invention that it can be automated particularly easily and efficiently. The person skilled in the art understands to this extent that an electronic data processing device will in most instances be used for this purpose to cause or promote controlling the application system or the method. For most types of application, an application system according to the invention is correspondingly relevant, wherein the application system comprises an electronic data processing device for controlling the application system.

For substantially all embodiments, an application system according to the invention is relevant, wherein the automated motion unit is a robotic arm. Of particular practical relevance is an application system according to the invention, wherein the application device is disposed in a workstation of a production line and/or wherein the dispenser device is disposed outside a workstation of a production line.

Particularly relevant for larger production lines is an application system according to the invention, wherein the application system comprises two or more application devices and/or dispenser devices, wherein advantageously several application devices can be simultaneously fed from a dispenser device.

The dispenser device serves in the application system according to the invention to generate the specific adhesive element arrangement for the substrate to be bonded, i.e. the sequence of different adhesive elements, which in the method according to the invention can be transferred to the application device and be dispensed from there.

To enable this functionality, the dispenser device initially comprises two or more dispenser units. These dispenser units are used to provide adhesive elements which can differ, for example, in terms of their dimensions or the chemical nature of the respective adhesive compound. The higher the number of dispenser units, the greater the flexibility with regard to the adhesive elements that can be applied with the application system. Correspondingly preferable is an application system according to the invention, wherein the dispenser device comprises three or more, preferably four or more, particularly preferably five or more, dispenser units.

It can be seen as an advantage of the application system according to the invention that it has a great flexibility with regard to the adhesive elements to be used. In principle, it is thus possible to dispense a large multiplicity of different adhesive elements with the application system, for example also adhesive strips, adhesive films or similar. In view of the high industrial relevance, however, it is particularly preferred to design the application system for the application of so-called die-cut blanks. Correspondingly preferably is an application system according to the invention, wherein the adhesive elements are die-cut blanks.

As understood by the person skilled in the art, the adhesive elements in most instances have in common that they have an adhesive layer and a carrier layer. In view of the practical requirements, pressure-sensitive adhesive elements are particularly relevant among the adhesive elements. Relevant for substantially all embodiments is an application system according to the invention, wherein the adhesive elements comprise a carrier layer and an adhesive layer connected thereto. An application system according to the invention is expedient, wherein the side of the adhesive elements facing away from the adhesive layer is formed by the carrier layer. Particularly preferable herein is an application system according to the invention, wherein the adhesive elements are pressure-sensitive adhesive elements, and/or wherein the adhesive layer comprises a pressure-sensitive adhesive compound, wherein the adhesive layer preferably consists of a pressure-sensitive adhesive compound.

In principle, all industry-standard adhesive compounds, for example adhesive compounds based on synthetic rubbers or poly(meth)acrylates, are suitable for the adhesive layers. With regard to the carrier layer, an application system according to the invention is exemplary, wherein the carrier layer comprises one or more materials which are selected from the group consisting of polyethylene, polypropylene, cyclic olefin copolymers, polyvinyl chloride, polyester, ethylene vinyl alcohol, polyvinylidene chloride, polyvinylidene fluoride, polyacrylonitrile, polycarbonate, polyamide, polyether sulfone and polyimide, preferably is selected from the group consisting of polyethylene, polypropylene and polyethylene terephthalate, wherein the carrier layer preferably consists of these materials.

Even if it is at least theoretically conceivable to apply only identical adhesive elements with the application system according to the invention, the person skilled in the art understands that the advantages of the application system according to the invention and the method based on it arise precisely when different adhesive elements are to be applied, which differ in their properties and are optimized for the requirements of the adhesive position to be respectively bonded on the substrate. Correspondingly preferable is an application system according to the invention, wherein the adhesive elements of different dispenser units differ in terms of one or more properties, which are selected from the group consisting of the chemical composition of the adhesive layer, the carrier material of the carrier layer, the shape of the adhesive elements and the dimensions of the adhesive elements, preferably the dimensions of the adhesive elements.

In the dispenser device, the adhesive elements can be expediently provided as pre-singularized adhesive elements on an adhesive tape roll, wherein they can be disposed, for example, with the adhesive layer on a reduced-adhesion liner from which they are separated when being delivered from the dispenser unit. In addition to the use of already singularized adhesive elements, it is also conceivable however that the production of the adhesive elements to be applied later takes place only in the dispenser device, which is accordingly set up for this purpose, which can be implemented in stationary dispenser devices for example by cutting units with oily knives or laser radiators also with comparatively complex and/or maintenance-intensive methods. In this case, the dispenser device comprises a so-called adhesive element precursor. As understood by the person skilled in the art, such an adhesive element precursor is a semi-finished product from which the adhesive elements can be produced. Particularly relevant examples are again adhesive rolls of continuous adhesive tapes, from which adhesive elements can be obtained by singularization, in order to obtain the corresponding adhesive elements to be applied, for example, by separating and/or cutting out, for example cutting off or punching out, adhesive elements. Preferable is an application system according to the invention, wherein the dispenser units comprised the adhesive elements on an adhesive tape roll and/or the dispenser units as the adhesive element precursor comprise an adhesive tape roll and a cutting device. Particularly preferable is an application system according to the invention, wherein the dispenser units comprise in each case a multiplicity of adhesive elements, preferably on an adhesive tape roll.

As understood by the person skilled in the art, the two or more dispenser units can be partially interconnected or otherwise structurally linked to one another. For example, two adhesive tape rolls with adhesive elements as the first and second dispenser unit can be connected to the same drive and/or control unit and/or disposed conjointly in a housing. Accordingly, a plurality of dispenser units of the dispenser device, for example in the form of adhesive tape rolls with adhesive elements and an associated guiding system, can be a constituent part of a larger dispenser structure.

In a preferred embodiment, the dispenser units per se as an entity are disposed so as to be reversibly non-destructively releasable in the dispenser device. In particular, a configuration is preferred in which the dispenser units are designed as refill cartridges, which can be inserted so as to be reversibly and non-destructively releasable in cartridge receptacles of the dispenser device that are provided for this purpose. For this purpose, an application system according to the invention is preferable, wherein the dispenser units are disposed so as to be reversibly and non-destructively releasable in the dispenser device.

As explained above, the dispenser units each serve to deliver the adhesive elements provided therein to the downstream system in the method. This can be enabled, for example, in that the dispenser units have a dispensing region in which the adhesive elements are accessible from the outside, so that they can be received by a transfer element, for example a suction gripper. Since the use of corresponding transfer elements in the context of “pick & place”, which is also described more comprehensively hereunder with regard to the adhesive element guiding system, is considered comparatively complex, it is preferable according to the opinion of the inventors to instead equip the dispenser units with a dispensing edge, sometimes also referred to as a knife edge. The concept of a dispensing edge is readily familiar to the person skilled in the art of adhesive technology. Dispensing edges serve to separate adhesive elements from an underlying web-shaped separation material having a reduced-adhesion surface, for example a liner. The material tape with the web-shaped separation material and the adhesive elements disposed thereon is fed to the dispensing edge, wherein the web-shaped separation material is guided tightly about the dispensing edge at the end of said dispensing edge, the latter in most instances having a very small radius of curvature. As a result of the inherent stiffness of the adhesive element, which is greater than the adhesion to the web-shaped separation material, the adhesive element cannot follow this movement of the separation material and is instead gradually detached from the separation material, the further the material tape is guided over the dispensing edge. The adhesive element thus is pushed beyond the dispensing edge while being detached from the web-shaped separation material and can be transferred, for example, to a carrier structure adjoining the dispensing edge, for example a conveyor belt. Therefore, an application system according to the invention is preferable, wherein the dispenser units have a dispensing edge, preferably a stationary dispensing edge, and are configured to deliver the adhesive elements at the dispensing edge and to transfer them to the adhesive element guiding system. In the context of a functional description, whether a constructive guide element is a dispensing edge depends on whether the corresponding adhesive elements can be separated from an underlying web-shaped separation material on this guiding element. In practice, the person skilled in the art adapts the constructive design, i.e., for example, the radius of curvature at the edge, in particular to the adhesion of the adhesive elements at the web-shaped separation material and the stiffness of the adhesive elements.

In addition to the dispenser units, the dispenser device comprises a so-called transfer unit which comprises a revolving conveyor belt having a reduced-adhesion surface and a dispensing edge. This transfer unit serves the purpose that the specific sequence of adhesive elements, i.e. the adhesive element arrangement of a multiplicity of adhesive elements, is generated on said transfer unit. Moreover, the transfer unit serves to transfer the adhesive element arrangement, which has been assembled in the transfer unit, to the application device. For implementing the transfer functionality, the transfer unit comprises a revolving conveyor belt, which has a reduced-adhesion surface and a dispensing edge. The combination of a reduced-adhesion surface, which prevents the adhesive elements from sticking too strongly on the transfer unit, when interacting with the dispensing edge, makes it possible to separate the adhesive elements of the adhesive element arrangement at the dispensing edge that are disposed on the transfer unit from the reduced-adhesion surface again, so that the adhesive elements move beyond the dispensing edge and can be transferred to the conveyor element of the application device that is described further below, if the latter in the transfer position, for example, is disposed in line with the revolving conveyor belt of the transfer unit. The inventors also refer to corresponding revolving conveyor belts as transfer belts.

As understood by the person skilled in the art, a reduced-adhesion surface is designed in such a way that the adhesive elements, or their adhesive layers, display reduced, or an overall low, adhesion to the surface. A corresponding design embodiment is able to be readily implemented by the person skilled in the art aware of the invention, since they know the concept of reduced-adhesion surfaces from many other fields of adhesive technology, where it is used regularly, for example, in conjunction with typical liners. In practice, it is difficult to specify absolute values pertaining to the acting forces and the necessary degree of adhesion reduction. The adhesive forces tolerable between the adhesive elements and the reduced-adhesion surface of the conveyor element substantially depend on the physical-chemical properties of the adhesive compound used, in particular their cohesion, as well as the design of the dispensing edge, which determines the forces acting during detachment. In practice, the selection of the adhesive compound used in the adhesive layer of the adhesive elements will in most cases depend on the application needs that are set for the bonding strength to the substrate to be bonded or other application requirements. The person skilled in the art, who has identified an adhesive compound suitable for the interaction with the substrate, can then make a suitable selection for the material of the conveyor element or for its coating, to which the respective adhesive compounds display sufficiently low adhesion that the adhesive elements can be separated from the reduced-adhesion surface without cohesive failure on the dispensing edge. In other words this is an application system according to the invention, wherein the reduced-adhesion surface is designed in such a way that the adhesion between the adhesive elements and the reduced-adhesion surface is smaller than the cohesion of the adhesive compound of the adhesive layer and/or is smaller than the extracting forces acting during delivery at the dispensing edge between the adhesive elements and the reduced-adhesion surface, preferably by 30% or more, preferably by 60% or more, particularly preferably by 90% or more. In this context, the inventors propose that additionally or alternatively the degree of adhesion of the adhesive element to the reduced-adhesion surface can be specified expediently also in relation to the adhesion of the adhesive element at the substrate to be bonded, since these interactions should be purposefully significantly greater than the adhesion of the adhesive element to the conveyor element. Accordingly, an application system according to the invention is preferable, wherein the reduced-adhesion surface is designed in such a way that the adhesion of the adhesive element to the reduced-adhesion surface is smaller, preferably by 80% or more, particularly preferably by 90% or more, most preferably by 95% or more, than the adhesion of the adhesive element at the substrate to be bonded.

At least in principle, it is possible to form the surface of the conveyor belt to be reduced in terms of adhesion by making the entire support face of the conveyor belt of a material to which the specific adhesive elements display reduced adhesion. Analogously to the technology used in typical liners, however, it is preferable to implement the desired adhesion reduction by coating the surface of the conveyor belt with a so-called release layer, which can be particularly preferably a silicone-based release layer. Correspondingly, an application system according to the invention is preferable, wherein the reduced-adhesion surface is coated with a release layer, preferably with a silicone release layer, wherein the silicone release layer is preferably producible by crosslinking a crosslinkable silicone system comprising one or more polysiloxanes.

Even if it is at least theoretically possible to embody the conveyor belt of the transfer unit to be movable in the dispenser device, for example in order to be able to displace it toward the application device to be fed, this is not preferred with regard to the constructive design of the dispenser device. Instead, an application system according to the invention is preferable, wherein the conveyor belt of the transfer unit is disposed in a fixed position in the dispenser device.

Since a movement of the conveyor belt of the transfer unit is not preferred anyway and there are also few reasons for providing complex guiding of the adhesive elements in the transfer unit, in which the adhesion of the adhesive elements on the reduced-adhesion surface would have to be greater than the force of gravity to avoid the adhesive elements from falling off, the revolving conveyor belt in the dispenser device can advantageously be designed in a structurally very simple manner. A design embodiment in the manner of a suction belt, as described hereunder for the revolving conveyor element of the application device, is thus possible, but not necessary in the vast majority of cases.

The person skilled in the art understands that the adhesive element arrangement generated in the transfer unit comprises a multiplicity of adhesive elements which are expediently disposed in a more or less straight row and will in most cases be at least slightly spaced apart from one another to prevent unwanted bonding between the adhesive elements.

In the method according to the invention, the different adhesive elements of the dispenser units are to be transferred to the revolving conveyor belt of the transfer unit and hereby be brought into a specific arrangement. In order to enable this, the dispenser device comprises means which are designed for this purpose and are referred to in the present case as an adhesive element guiding system. The term “adhesive element guiding system” abstracts the various possibilities known to the person skilled in the art for disposing the adhesive elements delivered by dispenser units in a specific arrangement on the transfer unit. In a first design embodiment, the adhesive element guiding system can comprise, for example, transfer elements, for example movable suction grippers, which, in analogy to the concept of “pick & place”, receive the adhesive elements from the dispenser units and dispose them in provided places on the revolving conveyor belt of the transfer unit in order to generate the adhesive element arrangement. In this case, this is an application system according to the invention, wherein the adhesive element guiding system comprises one or more transfer elements, wherein the transfer elements are configured to receive adhesive elements delivered by the dispenser units so as to form a reversibly and non-destructively releasable connection and to position them on the reduced-adhesion surface of the transfer unit, wherein the adhesive element guiding system preferably comprises two or more, particularly preferably four or more, transfer elements, most preferably a separate transfer element for each dispenser unit.

Even if generating a predetermined adhesive element arrangement from different adhesive elements of different dispenser units with a corresponding adhesive element guiding system based on transfer elements is possible, a corresponding construction will, according to the opinion of the inventors, however, be associated with a relatively high complexity in equipment. Accordingly, the inventors propose that in a particularly preferred embodiment, dispenser units with dispensing edges can be used, which are disposed in such a way that they transfer their adhesive elements to a revolving conveyor belt of the adhesive element guiding system, on which the adhesive elements are guided in the direction of the transfer unit. Advantageously, the desired adhesive element arrangement can be generated in that the adhesive elements are transferred sequentially, i.e. successively, to the conveyor belt of the adhesive element guiding system and thus guided to the transfer unit so that they arrive in the desired sequence at the transfer unit. Correspondingly, an application system according to the invention is preferable, wherein the adhesive element guiding system comprises at least one revolving conveyor belt having a reduced-adhesion surface. Particularly preferred is an application system according to the invention, wherein the revolving conveyor belt of the adhesive element guiding system is disposed in such a way that the dispenser units can transfer the adhesive elements delivered by them via a dispensing edge directly to the revolving conveyor belt of the adhesive element guiding system.

For the transfer of the adhesive elements from a corresponding revolving conveyor belt of an adhesive element guiding system to the revolving conveyor belt of the transfer unit, at least theoretically again, the use of transfer elements, for example with a suction function, is considered, wherein this in turn is associated with relatively high complexity in equipment. Analogous to the above embodiments, it is in turn preferred to implement the transfer via a dispensing edge, wherein the above explanations pertaining to the dispensing edge and to the reduced-adhesion surface apply correspondingly. An application system according to the invention is preferable, wherein the transfer unit comprises one or a plurality of transfer elements, wherein the transfer elements are configured to receive adhesive elements guided on the revolving conveyor belt of the adhesive element guiding system, so as to form a reversibly and non-destructively releasable connection, and to position said adhesive elements on the reduced-adhesion surface of the conveyor belt of the transfer unit. Particularly preferred is an application system according to the invention, wherein the revolving conveyor belt of the adhesive element guiding system in the transition region to the transfer unit comprises a dispensing edge, wherein the revolving conveyor belt of the adhesive element guiding system is disposed in such a way that the adhesive elements conveyed on the conveyor belt can be transferred via the dispensing edge directly to the revolving conveyor belt of the transfer unit.

In addition to the dispenser device, which can produce the substrate-specific adhesive element arrangement, the application system according to the invention also comprises an application device, which in the method according to the invention performs the actual bonding of the substrate. According to the invention, the application device is spaced apart from the dispenser device, i.e. this is in particular not an application system in which the dispenser device is integrated into the application device. The application device is disposed on an automated motion unit, in particular a robotic arm, and thereby movable per se in space. The corresponding application device is thus an end effector which is disposed, for example, on an industrial robot. As understood by the person skilled in the art, an end effector is the executing and/or terminating element of automated motion units, for example robotic arms. In other words, end effectors in the field of robotics are the last components of a kinematic chain, which are usually designed to carry out an order predefined by an external control device, optionally conjointly with the automated motion unit to which said end effectors are fastened.

This application device comprises as a central constituent part a conveyor element which in turn comprises or consists of a revolving conveyor belt having a reduced-adhesion surface. This conveyor element is used with the revolving conveyor belt to acquire the adhesive element arrangement provided by the transfer unit in a transfer position from the dispenser device, and supports the multiplicity of adhesive elements of the adhesive element arrangement during the use of the application device in the application mode, wherein the revolving conveyor belt also has the task of moving the adhesive elements successively into the region of influence of the application element, so that the application element can lift the adhesive elements successively from the revolving conveyor belt and apply them to the substrate. An application system according to the invention is preferable for this purpose, wherein the conveyor belt is disposed in a fixed position in the application device.

In order to facilitate the understanding of the present invention and to enable a clear definition, it is defined within the scope of the invention that the revolving conveyor belt extends through at least three different regions. These different regions are distinguished by their role which they play in the operation of the application system, and are accordingly referred to as the receiving region, the retrieving region and the reservoir region. This distinction of the regions serves as the functional description of the invention, wherein advantageously no sharp distinction of the regions is necessary, and individual regions can also be present in multiples, for example multiple retrieving regions in the case of a plurality of application elements.

The receiving region is the part of the revolving conveyor belt in which the adhesive elements guided over the dispensing edge of the transfer unit are placed in the transfer position on the reduced-adhesion surface of the conveyor element. The person skilled in the art understands to the extent that, for example at a synchronous revolving speed between the conveyor belts of the conveyor element and of the transfer unit, the adhesive element arrangement is transferred piece by piece to the conveyor belt of the conveyor element without the spacing between the adhesive elements changing. In order to allow another adhesive element to be received in the receiving region, the adhesive element previously disposed on the surface is conveyed onward by way of the conveyor belt of the conveyor element.

After all adhesive elements have been acquired from the transfer unit, all adhesive elements—except one if necessary—are present outside the receiving region. The region outside the receiving region, in which the adhesive elements lie during the subsequent application process and wait to be supplied to the application element, is presently referred to as a reservoir region, because it is, so to speak, the reservoir from which the adhesive elements disposed in the specific sequence are provided during the application process. In addition to the receiving region and the reservoir region, the retrieving region is defined, whereby this refers to the part of the revolving conveyor belt in which the application element receives the adhesive elements to be applied, in order to then adhere them to the substrate. In an exemplary design embodiment, the retrieving region adjoins the receiving region in the revolving direction of the conveyor belt, whereas the reservoir region is located in the revolving direction behind the retrieving region. In this case, this is an application system according to the invention, wherein the retrieving region is disposed between the receiving region and the reservoir region. In such a design embodiment, the adhesive elements acquired from the transfer unit are thus placed piece by piece on the surface of the conveyor belt in the receiving region and guided through the retrieving region into the reservoir region in order, so to speak, to fill the reservoir with adhesive elements.

The person skilled in the art understands that the conveyor element for the adhesive elements represents a kind of buffer storage during the application process. Accordingly, the length of the conveyor element is of particular importance, as this determines how many adhesive elements the application device can accommodate, depending on the dimensions of the adhesive elements, before it has to be populated again. In this context, an application system according to the invention is preferable, wherein the conveyor belt of the conveyor element has a length of the revolving face in the range of 50 to 2000 cm, preferably in the range of 100 to 1000 cm, particularly preferably in the range of 150 to 500 cm. Additionally or alternatively preferable is an application system according to the invention, wherein the conveyor belt of the conveyor element is longer in a related manner than the conveyor belt of the transfer unit.

It is expedient to design the conveyor belt so that a specific minimum number of adhesive elements can be temporarily stored thereon. Accordingly, it is expedient to specify the length of the conveyor belt or the available support face in the revolving direction relative to the adhesive elements. However, this has the disadvantage that a constructive feature of the application system must be defined via a consumption component. However, since the width of the conveyor belt used is advantageously in most instances very close to the largest diameter of the adhesive elements for weight reasons, an expedient size relation can also be defined with respect to the width of the conveyor belt. An application system according to the invention is preferable, wherein the conveyor belt of the conveyor element has a length of the revolving face in the range of 10*d to 100*d, preferably in the range of 15*d to 80*d, particularly preferably in the range of 20*d to 60*d, most preferably in the range of 25*d to 40*d, where d is the largest diameter of the different types of adhesive elements of the dispenser units. Additionally or alternatively preferable is an application system according to the invention, wherein the conveyor belt of the conveyor element has a length of the revolving face in the range of 10*b to 100*b, preferably in the range of 15*b to 80*b, particularly preferably in the range of 20*b to 60*b, most preferably in the range of 25*b to 40*b, where b is the width of the conveyor belt of the conveyor element orthogonal to the revolving direction.

With regard to the implementation of the reduced-adhesion surface, the principles already defined above for the conveyor belt of the transfer unit apply to the revolving conveyor belt of the conveyor element, in particular with regard to the design with a release layer. However, since the adhesive elements located on the conveyor belt of the conveyor element are not delivered via a dispensing edge, but must be detached from the reduced-adhesion surface by the application element, it is expedient to specify the extent of the adhesion reduction relative to the bonding strength that can be applied by the application element when receiving, because this bonding strength should be significantly larger than the adhesion of the adhesive element to the reduced-adhesion surface in order to allow receiving. An application system according to the invention is preferable, wherein the reduced-adhesion surface is coated with a release layer, preferably with a silicone release layer, wherein the silicone release layer is preferably producible by crosslinking a crosslinkable silicone system comprising one or more polysiloxanes. Additionally or alternatively preferred is an application system according to the invention, wherein the reduced-adhesion surface is designed in such a way that the adhesion of the adhesive elements to be applied to the reduced-adhesion surface is smaller, preferably by 50% or more, particularly preferably by 70% or more, most preferably by 90% or more, than the bonding strength between the application element and the adhesive element when receiving the adhesive element with the application element. Functionally defined is additionally or alternatively preferably an application system according to the invention, wherein the reduced-adhesion surface is designed in such a way that the adhesion between the adhesive elements and the reduced-adhesion surface is smaller than the cohesion of the adhesive compound of the adhesive layer and/or is smaller than the extracting forces acting in the receiving of the adhesive elements between the adhesive elements and the reduced-adhesion surface, preferably by 30% or more, preferably by 60% or more, particularly preferably by 90% or more.

Unlike the conveyor belt of the transfer unit, it is explicitly preferred for the conveyor belt in the application device to embody the latter with a suction function. In a corresponding design embodiment, continuous recesses are provided on the surface of the conveyor element, by means of which a negative pressure acting in the interior of the conveyor belt guarantees an additional contact pressure force of the adhesive elements to the conveyor belt. This ensures a firmer fit of the adhesive elements on the reduced-adhesion surface, so that they do not slip or fall off during the displacement of the application device, even if the adhesive elements are disposed overhead and gravity acts accordingly. A particular advantage of this configuration can be seen in particular in that, when viewed in the vertical direction, the lower side of the revolving conveyor belt thus also becomes accessible as an additional provision space for the adhesive elements of the adhesive element arrangement, whereby a larger part of the revolving face that can be used as a reservoir region is available at a reduced absolute length of the conveyor belt. A corresponding suction function and the design as a suction belt are known to the person skilled in the art from the prior art and to be implemented by the use of a pump, wherein the inventors propose to provide in the retrieving region, if necessary, blocking elements which, due to their no-flow zone, cause a reduced suction effect in the region in which the application element receives the adhesive elements. Particularly preferred is thus an application system according to the invention, wherein the conveyor belt of the conveyor element comprises a suction function for fixing the adhesive elements on the surface of the revolving conveyor element.

In order to enable a particularly reliable, reproducible and precise application of the adhesive elements, it is desirable that these can be received in a reproducible manner by the application element. For this purpose, it is expedient that the adhesive elements are always disposed identically at the point of time of being received in the retrieving region. For this purpose, the inventors propose the use of stop elements which can be disposed above the conveyor belt to allow the positioning to be finely adjusted. Preferable in this design embodiment is an application system according to the invention, wherein the application device comprises a stop element, wherein the stop element is configured to fix the position of adhesive elements disposed on the conveyor belt of the conveyor element in the conveying direction of the, so that the adhesive elements are moved in the movement of the conveyor element relative to the reduced-adhesion surface, wherein the stop element is preferably configured to change the position of adhesive elements disposed on the conveyor belt of the conveyor element transversely to the conveying direction.

If, in view of the structural design with respect to the circulation direction, the reservoir region is located between the receiving region and the retrieving region, the supply of the adhesive elements from the reservoir region to the retrieving region can be performed with the same direction of circulation that also enables the adhesive elements to be acquired from the transfer unit. This also applies to design embodiments in which the retrieving region is disposed in the revolving direction between the receiving region and the reservoir region, provided it is possible, for example due to a suction function of the conveyor belt, to displace the adhesive elements about the entire conveyor element from the reservoir region back into the retrieving region. In particular, if no suction function is provided, it is however preferable in this design embodiment to design the application device in such a way that the revolving direction of the conveyor belt can be reversed if required. Correspondingly, an application system according to the invention is preferable, wherein the application device is configured in such a way that the conveying direction of the conveyor belt of the conveyor element can be reversed.

As explained above, it can be seen as a major advantage of the application system according to the invention that it is not dependent on the use of receptacles for adhesive tape rolls or refill cartridges in the end effector. The corresponding application devices can be embodied particularly light in particular as a result. The person skilled in the art understands to this extent that, in order to exploit these advantages, it is also preferable to implement a corresponding light and/or simple design embodiment of the application device. Accordingly, an application system according to the invention is preferable, wherein the application device does not comprise a receptacle for adhesive tape rolls and/or wherein the application device does not comprise a receptacle for refill cartridges. Additionally or alternatively preferably is an application system according to the invention, wherein the application device has a total weight in the range of 1 to 40 kg, preferably in the range of 2 to 30 kg, particularly preferably in the range of 4 to 20 kg.

It can be seen as an advantage of the application system according to the invention that the latter, in terms of the design embodiment of the application element, i.e. the constituent part responsible for the final attachment to the substrate, if said application element can receive an adhesive element from the conveyor element. Conceivable for the application of adhesive strips in this context are in particular application rollers, for example, which can form a reversibly and non-destructively releasable connection to an adhesive strip, or its carrier layer, disposed on the conveyor belt, via a suction function in order to subsequently align said adhesive strip on the substrate by rotation and to roll said adhesive strip onto said substrate. However, according to the opinion of the inventors, systems that in turn use a “pick & place” concept for the application element are very particularly preferred.

With regard to the practical implementation of the application functionality, in the vast majority of cases a requirement will be that the application element should be configured to be able to form a reversibly and non-destructively releasable connection to an adhesive element or its carrier layer. For this purpose, the person skilled in the art can in principle resort to various solutions known from the prior art.

The person skilled in the art understands that the above-described device of the application element being able to form a reversibly and non-destructively releasable connection to an adhesive element does not require that the dissolution of the connection must be effected by the elimination of the connecting force such as would be achievable, for example, when switching off a magnetic field in the case of a magnetic connection or by switching off a suction function. Instead, it is also possible and in practice often even particularly efficient when the reversible and non-destructive dissolution is carried out counter to the acting forces that cause the connection. In particular, it can be exploited that the adhesion of the adhesive elements to the substrate is in many cases significantly greater than the force causing the connection to the application element, so that the connection can take place, for example, counter to a negative pressure with a suction effect, when the application element is guided away from the substrate.

The reversibly and non-destructively releasable connection can be provided at least in theory, for example, by a magnetic arrangement, which interacts, for example, with a magnetic carrier layer of the adhesive elements, or theoretically can also be provided via suction cups or a pressure-sensitive adhesive compound. However, the use of a vacuum-based suction solution is particularly preferred due to the high reliability, the simple design implementation and the longevity of such a solution.

In the opinion of the inventors, an application element is particularly preferred, which comprises a piston assembly having at least one suction gripper disposed on a displaceable piston, since a particularly precise and efficient application of the adhesive elements is possible with these application elements. In this case, the application element is aligned with the conveyor element, and the controllable suction gripper with the movable piston is lowered onto the conveyor belt of the conveyor element in the retrieving region, in order to contact the adhesive element, located thereon, on the carrier layer with the suction gripper and to establish a connection in a reversible and non-destructive manner. By displacing the piston again, the adhesive element can be lifted from the conveyor element and aligned in the direction of the substrate by means of the motion unit, before an application movement occurs, which contacts the adhesive layer with the substrate, so that the connection between the adhesive element and the application element can be dissolved. Correspondingly, an application system according to the invention is preferable, wherein the application element comprises a motion unit and a receptacle unit disposed on the motion unit, wherein the receptacle unit is configured to form a reversibly and non-destructively releasable connection to the carrier layer of the adhesive elements. In this context, an application system according to the invention is particularly preferable, wherein the receptacle unit comprises one or more controllable suction grippers, wherein the application device preferably comprises one or more vacuum pumps connected to the suction grippers. Additionally or alternatively preferable is an application system according to the invention, wherein the motion unit comprises a piston assembly having a cylinder and a piston displaceable in the cylinder, wherein the motion unit preferably comprises a rotation device for rotation of the piston assembly, wherein the rotation axis preferably extends substantially parallel to the surface of the conveyor element of the conveyor unit.

In particularly preferred design embodiments, the application element can be embodied as a rotatable application element which comprises a corresponding displaceable piston plus suction gripper on both sides. In this way, after receiving a first adhesive element, the application element can be rotated about a rotational axis in order to align the received adhesive element in the direction of a substrate onto which said adhesive element can be pressed by displacing the piston. In the meantime, on the rear of the application element, another displaceable piston having a corresponding suction gripper is ready to receive another adhesive element for the next application.

In a preferred embodiment, the different sizing of the suction grippers at the different ends of the motion unit enables an efficient application of adhesive elements of different geometric shape and/or different dimensions. If, for example, two types of adhesive elements with very different dimensions, e.g. small and large adhesive elements, are to be provided in the adhesive element arrangement, an application of the differently sized adhesive elements can be performed in this embodiment in that the receptacle face of the two suction grippers is selected correspondingly to the two different diameters of the adhesive elements. This provides an application system according to the invention, by way of which a precise application of differently sized adhesive elements is enabled particularly efficiently without requiring a change of the application element. Particularly preferred is an application device according to the invention, wherein the application element comprises two or more receptacle units, wherein the receptacle units preferably have different dimensions. Based on this concept, application devices according to the invention are also preferable, wherein the application element comprises 3 or more, preferably 4 or more, particularly preferably 5 or more, receptacle units, wherein the receptacle units preferably have different dimensions. However, additionally or alternatively, it is also possible to provide two or more application elements, which in turn are designed for the optimal application of one or more adhesive elements, and to use these adhesive elements in a manner specific to the adhesive element.

Receiving adhesive elements by way of the application element can be performed as understood by the person skilled in the art by a relative movement between the application element and the conveyor element, wherein the relative movement can also be achieved, for example, in that, after contacting the adhesive element by the application element, the conveyor element is moved away so that the adhesive element remains on the application element. In this way, for example, a non-rotatable suction gripper can also be implemented as an application element. The latter can be lowered, for example, onto the adhesive element by way of the piston assembly in order to establish the contact. The conveyor element is subsequently pulled away from under the non-rotatable suction gripper, whereupon the non-rotatable suction gripper is further deployed out of the piston assembly in order to thereby perform an application movement past the withdrawn conveyor element.

In the light of the above explanations, the invention relates to a dispenser device for use in an application system according to the invention, comprising:
a1) two or more dispenser units comprising in each case a plurality of adhesive elements, wherein the dispenser units are configured to deliver adhesive elements,
a2) an adhesive element guiding system, and
a3) a transfer unit comprising a revolving conveyor belt having a reduced-adhesion surface and a dispensing edge,
wherein the dispenser device is configured to transfer adhesive elements delivered from the dispenser units to the conveyor belt of the transfer unit by way of the adhesive element guiding system, and to hereby generate on the reduced-adhesion surface an adhesive element arrangement from a multiplicity of adhesive elements, wherein the adhesive element arrangement comprises adhesive elements from different dispenser units.

The invention correspondingly also relates to an application device for use in an application system according to the invention, comprising:
b1) a conveyor element comprising a revolving conveyor belt having a reduced-adhesion surface, which extends through a receiving region, a retrieving region and a reservoir region,
b2) an application element, and
b3) a fastening unit for fastening the application device to an automated motion unit,
wherein the application device is configured in such a way that a multiplicity of adhesive elements, which have been applied to the reduced-adhesion surface in the receiving region, can be conveyed into the reservoir region by way of the conveyor element and that an adhesive element located in the reservoir region can be conveyed into the retrieving region by way of the conveyor element,
wherein the application device is configured to receive an adhesive element disposed on the conveyor belt of the conveyor element in the retrieving region by way of the application element and to apply said adhesive element to a substrate to be bonded.

The invention furthermore relates to a method for applying adhesive elements to substrates to be bonded by an application system according to the invention, comprising the following method steps:
i) generating an adhesive element arrangement on the conveyor belt of the transfer unit of the application device, comprising a multiplicity of adhesive elements, wherein the adhesive element arrangement comprises adhesive elements from different dispenser units,
ii) moving the application device to the transfer position and transferring the adhesive element arrangement from the conveyor belt of the transfer unit to the conveyor belt of the conveyor element, wherein at least part of the transferred adhesive elements is conveyed into the reservoir region by way of the conveyor belt,
iii) conveying an adhesive element from the reservoir region into the retrieving region by way of the conveyor belt of the conveyor element,
iv) receiving the adhesive element in the retrieving region by way of the application element so as to form a reversibly and non-destructively releasable connection between the application element and the adhesive element, and
v) applying the received adhesive element to a substrate to be bonded and dissolving the connection between the application element and the applied adhesive element,
wherein method steps iii), iv) and v) are repeated to apply a multiplicity of adhesive elements, preferably all of the adhesive elements, of the transferred adhesive element arrangement, and wherein method steps i) and ii) are repeated after a multiplicity of adhesive elements, preferably all adhesive elements, of the previously transferred adhesive element arrangement have been applied.

Exemplary is a method according to the invention, wherein the revolving conveyor belt of the dispenser device and the revolving conveyor belt of the conveyor element are flush in the transfer position, so that the adhesive elements of the adhesive element arrangement can be transferred from the conveyor belt of the transfer unit via the dispensing edge to the conveyor belt of the conveyor element. Illustrative is a method according to the invention, wherein apart from one adhesive element all, preferably all, adhesive elements are conveyed into the reservoir region by way of the conveyor element.

Preferable is a method according to the invention, wherein the substrate to be bonded is a vehicle component, and/or wherein the substrate to be bonded comprises a recess, wherein the adhesive element is applied to seal, preferably to seal in a fluid-tight manner, the recess at least partially, preferably substantially completely.

In one embodiment, a method according to the invention is preferable, wherein two or more different substrates are bonded by an adhesive element arrangement transferred in method step ii).

Alternatively, a method according to the invention is preferable, wherein the adhesive element arrangement transferred in method step ii) comprises a number of adhesive elements corresponding to the number of positions to be bonded on the substrate. A method according to the invention is particularly preferable here, wherein the substrate to be bonded comprises a multiplicity of different adhesive positions to be bonded with different adhesive requirements, wherein the adhesive element arrangement transferred in method step ii) comprises different adhesive elements which are adapted to the different adhesive requirements of the adhesive positions.

Additionally or alternatively to the embodiments disclosed above, a method according to the invention is preferable, wherein the adhesive element arrangement transferred in method step ii) comprises adhesive elements from different dispenser units, wherein the sequence of the adhesive elements on the conveyor element is adapted to the work plan of the application device in such a way that the properties of the nth adhesive element on the conveyor element correlate with the adhesive requirements of the nth adhesive position actuated by the application device.

Preferred embodiments of the invention will be explained and described in more detail hereunder with reference to the appended figures. In the figures:

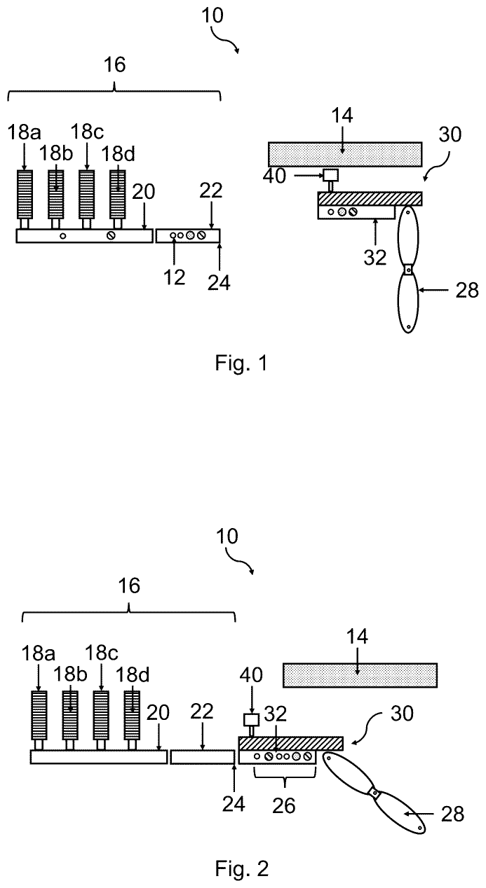

FIG. 1 shows a schematic illustration of a preferred application system according to the invention when carrying out the method according to the invention at a first point in time;

FIG. 2 shows a schematic illustration of a preferred application system according to the invention when carrying out the method according to the invention at a second point in time;

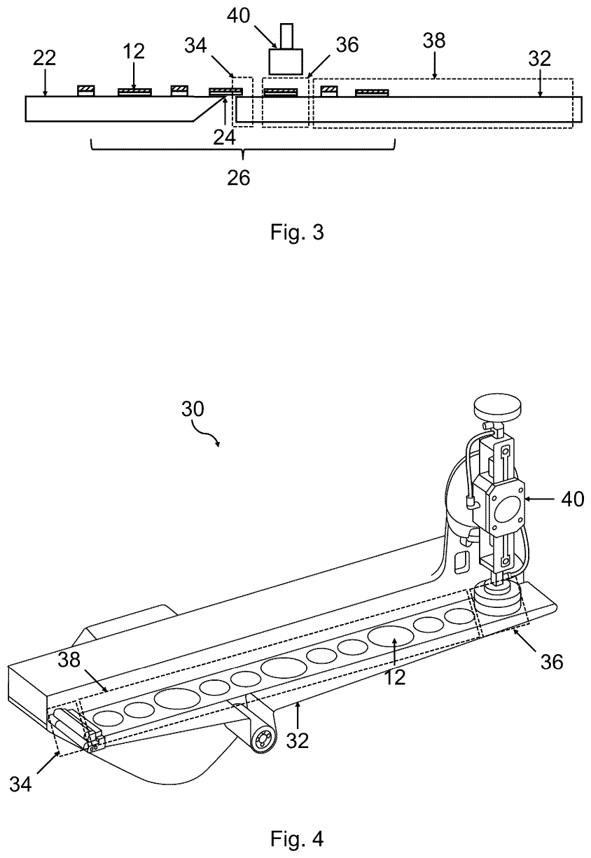

FIG. 3 shows a schematic lateral view of parts of a preferred application system according to the invention in the transfer position when carrying out the method according to the invention at a third point in time;

FIG. 4 shows a schematic illustration of a preferred application device according to the invention in a first perspective; and

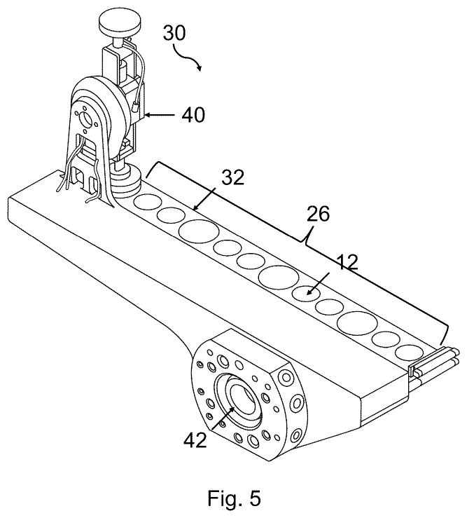

FIG. 5 shows a schematic illustration of the preferred application device according to the invention of FIG. 4 in a second perspective.

FIG. 1 shows a schematic illustration of a preferred application system 10 according to the invention when carrying out the method according to the invention for applying a multiplicity of adhesive elements 12 to a substrate 14 to be bonded at a first point in time.

The application system 10 comprises a dispenser device 16, having four separate dispenser units 18a, 18b, 18c, 18d, which are in each case designed as reversibly and non-destructively replaceable refill cartridges that can be inserted in corresponding receptacles of the dispenser device 16 and that comprise in each case a multiplicity of adhesive elements 12, which are disposed inside the refill cartridges in the form of adhesive tape rolls on a liner. For reasons of clarity, the drive and control units of the dispenser units 18a-d, which initiate the refill cartridges used in the receptacles of the dispenser device 16 to dispense adhesive elements 12, are not shown.

The adhesive elements 12 in the example shown are in each case tacky die-cut blanks and differ between the dispenser units 18a-d in terms of the geometric dimensions and/or the adhesive compound used, which is indicated in FIG. 1 by differently sized circle or different pattern fillings, wherein in the example shown only three of four possible adhesive elements 12 are incorporated into the adhesive element arrangement 26.

In the example shown, the dispenser units 18a-d are in each case equipped with a dispenser unit dispensing edge and disposed in such a way that they can transfer the adhesive elements 12 in each case directly to an adhesive element guiding system 20 which is embodied as a conveyor belt and on the surface of which the adhesive elements 12 display reduced adhesion as a result of siliconization. This adhesive element guiding system 20 transports the adhesive elements 12 in the direction of the transfer unit 22, wherein the adhesive elements are transferred via a guiding system dispensing edge to the revolving conveyor belt of the transfer unit 22, which likewise has a surface adhesion-reduced by siliconization.

In order to generate the optimal adhesive element arrangement 26 required for the bonding of the substrate 14, the dispenser device 16 is controlled by an electronic data processing device (not shown) so that the adhesive elements 12 arrive successively in the desired sequence at the transfer unit 22, this being able to be performed, for example, in that the adhesive elements 12 are delivered successively from the respective dispenser units 18a-d. On the conveyor belt of the transfer unit 22, an adhesive element arrangement 26 of a plurality of, densely packed and only slightly mutually spaced-apart adhesive elements 12 is obtained from the gradually acquired adhesive elements by controlling the step-by-step continued conveying movement that is adapted to the conveying speed of the adhesive element guiding system 20.

While the dispenser device 16 assembles the desired adhesive element arrangement 26, the application system 10 is simultaneously in the application mode in the example shown. In this case, the application device 30, which is designed in the example shown in FIG. 1 as the end effector of an industrial robot forming the automated motion unit 28, by way of its application element 40 successively applies the adhesive elements, which are disposed on the revolving conveyor belt of the conveyor element 32 which is embodied as a suction belt in the example shown and in which the desired adhesion reduction is in turn implemented by a silicone release layer. This takes place in that the application device 30 conveys the adhesive elements 12 successively into the influence region of the application element 40, receives them there and then dispenses them to the substrate 14. In this case, the application element 40 for reasons of clarity is plotted only using a schematic representation, but in terms of embodiment and arrangement corresponds to the construction shown in FIGS. 4 and 5.

After the application device 30 has dispensed the adhesive elements 12 held ready on the conveyor belt of the conveyor element 32, the application device 30 is moved by the automated motion unit 28 to the dispenser device 16 in order to move the application system 10 to the transfer position. This is schematically visualized in FIG. 2.

FIG. 2 schematically shows the preferred application system 10 according to the invention of FIG. 1, which has now been transferred to the transfer position. In this process, the revolving conveyor belts of the transfer unit 22 and of the conveyor element 32 are oriented flush with their surfaces, so that the adhesive elements 12 can be transferred from the transfer unit 22 to the revolving conveyor belt of the conveyor element 32 via the dispensing edge 24. FIG. 2 visualizes a point in time after the application device 30 has already acquired the adhesive element arrangement 26, which has been optimized for the bonding of the substrate and which has previously been assembled on the transfer unit 22 of the dispenser device 16, wherein the adhesive elements are already substantially in that part of the surface of the conveyor element 32 that is referred to in the context of the invention as the reservoir region 38 and is used, so to speak, for temporary storage of the adhesive elements.

FIG. 3 shows, independently of FIGS. 1 and 2, schematically in the lateral view, the moment of transfer of adhesive elements 12 of an adhesive element arrangement 26 between the revolving conveyor belts of a transfer unit 22 and a conveyor element 32. Clearly to be seen in FIG. 3 is in particular the dispensing edge 24 (which is schematically illustrated to be somewhat too pointed), wherein it is visualized how an adhesive element 12 pushes itself beyond the dispensing edge 24 as a result of the inherent stiffness and the acute withdrawal angle of the support surface and can be acquired from the conveyor belt of the conveyor element 32.

Plotted in FIG. 3 are in particular also the three regions used in the context of the present invention, in order to explain the functionality. The acquisition of the adhesive elements 12 takes place in the receiving region 34, this designating the part of the conveyor belt of the conveyor element 32 in which the adhesive elements 12 are placed during transfer. In the course of the transfer, the conveyor belt of the conveyor element 32 is moved in the same conveying direction as the conveyor belt of the transfer unit 22, so that the adhesive elements 12 are conveyed through the retrieving region 36 into the reservoir region 38. Receiving the adhesive elements 12 in the retrieving region 36 by the application element 40 takes place later in the application mode, while the adhesive elements 12 which are conveyed into the retrieving region 36 after the dispensing of the respectively preceding adhesive element 12 of the adhesive element arrangement 26 are kept ready in the reservoir region 38. Due to the arrangement of the retrieving region 36 between the receiving region 34 and the reservoir region 38, the conveying of adhesive elements 12 from the reservoir region 38 is carried out either by inverting the conveying direction or by utilizing the suction functionality in that the adhesive elements 12 of the adhesive element arrangement 26 are conveyed once completely around the conveyor belt. The person skilled in the art understands to this extent that the radii of curvature of the conveyor belt are chosen sufficiently large to prevent unwanted edges from being formed on which the adhesive elements 12 would be detached while revolving.

FIGS. 4 and 5 show a schematic illustration of a preferred application device 30 according to the invention in two different perspective illustrations. The reservoir region 38 of the conveyor belt of the conveyor element 32, which is embodied without a suction function, is completely occupied by adhesive elements of different size, so that FIGS. 4 and 5 show a state as may be present in particular immediately after leaving the transfer position. In FIG. 5, the fastening unit 42 can also be seen, by way of which the end effector can be fastened, for example, to a robotic arm.

A pressure roller positioned directly above the conveyor belt is provided at the receiving region 34, by way of which pressure roller the received adhesive elements 12 are rolled onto the reduced-adhesion surface of the conveyor belt in a controlled manner, in order to guarantee a minimum of adhesion and transfer that is insusceptible to error despite the adhesion reduction and also without a suction functionality. However, receiving can at least theoretically also be performed from the other side of the conveyor belt of the conveyor unit 32. As a consequence of the absent suction function, however, this requires that the conveying direction of the conveyor belt of the conveyor unit 32 can be reversed in order to subsequently move the adhesive elements 12 previously conveyed into the reservoir region 38 back to the retrieving region 36.

A preferred application element 40 can be particularly readily seen in FIGS. 4 and 5. The application element 40 comprises in the example shown a rotatable motion unit, which has on both sides a piston assembly having a cylinder and a piston which is displaceable in the cylinder and at the ends of which a suction gripper is in each case disposed, by way of which a connection to the adhesive element 12 to be applied can be established in a reversible and non-destructive manner.

### LIST OF REFERENCE SIGNS

10 Application system
12 Adhesive element
14 Substrate
16 Dispenser device
18a-d Dispenser unit
20 Adhesive element guiding system
22 Transfer unit
24 Dispensing edge
26 Adhesive element arrangement
28 Motion unit
30 Application device
32 Conveyor element
34 Receiving region
36 Retrieving region
38 Reservoir region
40 Application element
42 Fastening unit

1. An application system for applying a multiplicity of adhesive elements to substrates to be bonded, comprising:
a) a dispenser device comprising:
a1) two or more dispenser units, wherein each dispenser unit comprises a multiplicity of adhesive elements or at least an adhesive element precursor, wherein the two or more dispenser units are configured to deliver one or more adhesive elements,
a2) an adhesive element guiding system, and
a3) a transfer unit comprising a conveyor belt having a reduced-adhesion surface and a dispensing edge,
wherein the dispenser device is configured to transfer one or more adhesive elements delivered from the dispenser units to the conveyor belt of the transfer unit by way of the adhesive element guiding system, and to hereby generate, on the reduced-adhesion surface, an adhesive element arrangement from one or more adhesive elements, wherein the adhesive element arrangement comprises the one or more adhesive elements from different dispenser units,
and
b) an application device spaced apart from the dispenser device and is disposed on an automated motion unit, the application device comprising:
b1) a conveyor element comprising a conveyor belt having a reduced-adhesion surface, that extends through a receiving region, a retrieving region, and a reservoir region, and
b2) an application element,
wherein the application device is configured such that a multiplicity of adhesive elements, that have been applied to the reduced-adhesion surface in the receiving region, are movable into the reservoir region by way of the conveyor element and that at least one adhesive element of the multiplicity of adhesive elements located in the reservoir region is movable into the retrieving region by way of the conveyor element,
wherein the application device is configured to receive an adhesive element disposed on the conveyor belt of the conveyor element in the retrieving region by way of the application element and to apply the adhesive element to a substrate to be bonded,
wherein the application system is configured such that the application device is movable relative to the dispenser device to a transfer position by way of the automated motion unit, in which transfer position the application system is configured such that the adhesive elements of the adhesive element arrangement is movable over the dispensing edge onto the conveyor element by the transfer unit and in the receiving region be applied to the reduced-adhesion surface of the conveyor element such that at least part of the transferred adhesive elements is conveyed into the reservoir region by way of the conveyor element, and
wherein the application system is configured to, after transferring the adhesive elements of the adhesive element arrangement onto the conveyor element, in an application mode, convey adhesive elements from the reservoir region into the retrieving region, to receive the adhesive elements by way of the application element and to apply the adhesive elements to a substrate to be bonded.

2. The application system of claim 1, wherein the reduced-adhesion surface of the conveyor belt of the transfer unit and of the conveyor belt of the conveyor element is coated with a release layer.

3. The application system of claim 1, wherein the conveyor belt of the conveyor element has a length of the revolving face in the range of 10*b to 100*b, wherein b is the width of the conveyor belt of the conveyor element orthogonal to the revolving direction.

4. The application system of claim 1, wherein the conveyor belt of the conveyor element comprises a suction function for fixing the adhesive elements on the surface of the revolving conveyor element.

5. The application system of claim 1, wherein the application device is configured such that the conveying direction of the conveyor belt of the conveyor element is reversible.

6. The application system of claim 1, wherein the dispenser device comprises three or more dispenser units.

7. The application system of claim 1, wherein the dispenser units are disposed so as to be reversibly and non-destructively releasable in the dispenser device.

8. (canceled)

9. The application system of claim 1, wherein the application device further comprises:
b3) a fastening unit for fastening the application device to an automated motion unit,
wherein the application device is configured such that a multiplicity of adhesive elements, that have been applied to the reduced-adhesion surface in the receiving region, is movable into the reservoir region by way of the conveyor element and that an adhesive element located in the reservoir region is movable into the retrieving region by way of the conveyor element, and
wherein the application device is configured to receive an adhesive element disposed on the conveyor belt of the conveyor element in the retrieving region by way of the application element and to apply said adhesive element to a substrate to be bonded.

10. A method for applying adhesive elements to substrates to be bonded by an application system according to claim 1, the method comprising:
i) generating an adhesive element arrangement on the conveyor belt of the transfer unit of the application device, comprising a multiplicity of mutually spaced-apart adhesive elements, wherein the adhesive element arrangement comprises adhesive elements from different dispenser units,
ii) moving the application device to the transfer position and transferring the adhesive element arrangement from the conveyor belt of the transfer unit to the conveyor belt of the conveyor element, wherein at least part of the transferred adhesive elements is conveyed into the reservoir region by way of the conveyor belt,
iii) conveying an adhesive element from the reservoir region into the retrieving region by way of the conveyor belt of the conveyor element,
iv) receiving the adhesive element in the retrieving region by way of the application element so as to form a reversibly and non-destructively releasable connection between the application element and the adhesive element, and
v) applying the received adhesive element to a substrate to be bonded and dissolving the connection between the application element and the applied adhesive element,
wherein method iii), iv) and v) are repeated to apply a multiplicity of adhesive elements of the transferred adhesive element arrangement, and wherein i) and ii) are repeated after a multiplicity of adhesive elements of the previously transferred adhesive element arrangement have been applied.
